(19) United States
(12) Patent Application Publication
(10) Pub. No.: US 2011/0145862 A1
(43) Pub. Date: Jun. 16, 2011

(54) APPARATUS AND METHOD FOR PROVIDING PREVIEW CHANNEL GUIDE INFORMATION IN DIGITAL BROADCAST NETWORK

(75) Inventor: Jae-ho KIM, Daejeon (KR)

(73) Assignee: Electronics and Telecommunications Research Institute, Daejeon (KR)

(21) Appl. No.: 12/821,131

(22) Filed: Jun. 22, 2010

(30) Foreign Application Priority Data
Dec. 15, 2009 (KR) 10-2009-0124939

(51) Int. Cl. H04N 5/445

(52) U.S. Cl. 725/41

(57) ABSTRACT

An apparatus for providing preview channel guide information in a digital broadcast network includes: an encoding server for encoding respective broadcast program channel sources stored in multiple broadcast program databases; a broadcast control server for providing the respective encoded broadcast programs received from the encoding server by request from a mobile communication terminal; an electronic program guide (EPG) providing server for obtaining EPG information from a broadcast station; and a preview generation server for extracting preview layers from the respective encoded broadcast programs and combining the extracted preview layers with the EPG information provided from the EPG providing server to generate a preview channel, wherein the preview channel includes the combinations of the preview layers and the EPG information as sub-preview channels.

### CROSS-REFERENCE(S) TO RELATED APPLICATION(S)

The present invention claims priority of Korean Patent Application No. 10-2009-0124939, filed on Dec. 15, 2009, which is incorporated herein by reference.

### FIELD OF THE INVENTION

The present invention relates to an apparatus and method for providing preview channel guide information in a digital broadcast network; and, more particularly, to an apparatus and method, which provide a mobile communication terminal with multiple video previews and broadcast program information via digital television network.

### BACKGROUND OF THE INVENTION

As well-known, mobile communication terminals not only provide a voice or data communication function with other wired/wireless terminals but also provide digital television function and digital multimedia broadcast (DMB) function which allow users to watch various broadcast programs.

Therefore, a user who uses a mobile communication terminal can selectively view various broadcast programs by using a terrestrial wave or satellite DMB function while the user moves with his or her mobile communication terminal. However, if the user has preferable broadcast programs, the user needs to always remember those broadcast programs and the time for the broadcast programs.

The change from the existing analog broadcast to the digital broadcast is rapidly under way. Such a digital broadcast include digital cable broadcast, mobile digital broadcast, satellite digital broadcast, terrestrial wave digital broadcast, and the like. In these digital broadcasts, a significant delay may occur during a channel change.

The main reason of the delay during the channel change is due to a delay in control information processing required for channel change in a network and a delay that occurs when decoding encoded channel using the standard compression codec.

Recently, a variety of studies have been made to reduce the channel delay in the digital broadcast network. One of them utilizes electronic program guide (EPG) information. Conventionally, in the analog broadcast network with a short channel change delay time, the user sequentially conducts a channel change by pressing an up/down button, while in the digital broadcast network with a long channel change delay time, the user can effectively select a channel by using a preview service and an EPG service which provide various broadcast program information. Especially, there has been also recently proposed a technology which offers a photo- or image-based EPG service, rather than the existing text-based EPG service.

Moreover, a multiple layer encoding technology has been studied and developed to effectively support various user terminals with different data transfer rates and display sizes. A representative one of multiple layer encoding technologies is a scalable video coding (SVC) which consists of a base layer for providing the basic video quality and enhancement layers for improving the video quality by combination with the base layer.

In the above-stated conventional technologies, however, the preview service and the EPG service are conducted based on the digital television broadcast network. Thus, the broadcast network provider generates a real-time preview channel using additional expensive encoder equipment and provides it to the corresponding mobile communication terminal. This leads to an increase in a sensory channel delay time on the user side.

### SUMMARY OF THE INVENTION

In view of the above, the present invention provides an apparatus and method for providing preview channel guide information in a digital broadcast network, which encode respective broadcast program sources into multiple layers, extract preview layers from the respective broadcast programs encoded into multiple layers, combine the extracted preview layers and EPG information to organize the real-time preview channel, and then provide, upon channel change by a user, the preview channel to a corresponding mobile communication terminal via a digital television broadcast network.

In accordance with a first aspect of the present invention, there is provided an apparatus for providing preview channel guide information in a digital broadcast network, including:

an encoding server for encoding respective broadcast program channel sources stored in multiple broadcast program databases;

a broadcast control server for providing the respective encoded broadcast programs received from the encoding server by request from a mobile communication terminal;

an electronic program guide (EPG) providing server for obtaining EPG information from a broadcast station; and

a preview generation server for extracting preview layers from the respective encoded broadcast programs and combining the extracted preview layers with the EPG information provided from the EPG providing server to generate a preview channel, wherein the preview channel includes the combinations of the preview layers and the EPG information as sub-preview channels.

In accordance with a second aspect of the present invention, there is provided a method for providing preview channel guide information in a digital broadcast network, including:

encoding respective broadcast program channel sources stored in multiple broadcast program databases in response to a preview channel selection signal from a mobile communication terminal;

extracting preview layers from the encoded respective broadcast programs; and

combining the preview layers and EPG information received from a broadcast station to generate and transmit a preview channel to the mobile communication terminal, wherein the preview channel includes the combinations of the preview layers and the EPG information as sub-preview channels.

### BRIEF DESCRIPTION OF THE DRAWINGS

The objects and features of the present invention will become apparent from the following description of embodiments given in conjunction with the accompanying drawings, in which:

FIG. 1 illustrates a block diagram of an apparatus for providing preview channel guide information in a digital broadcast network in accordance with an embodiment of the present invention;

FIG. 2 shows a display of a preview channel generated by a preview generation server shown in FIG. 1 on a screen of a mobile communication terminal;

FIG. 3 is a flowchart sequentially illustrating a method for providing preview channel guide information in a digital broadcast network in accordance with the embodiment of the present invention; and

FIG. 4 provides a flowchart sequentially showing a control method of channel selection or channel change while providing preview channel guide information in a digital broadcast network in accordance with the embodiment of the present invention.

### DETAILED DESCRIPTION OF THE EMBODIMENTS

Hereinafter, embodiments of the present invention will be described in detail with reference to the accompanying drawings which form a part hereof.

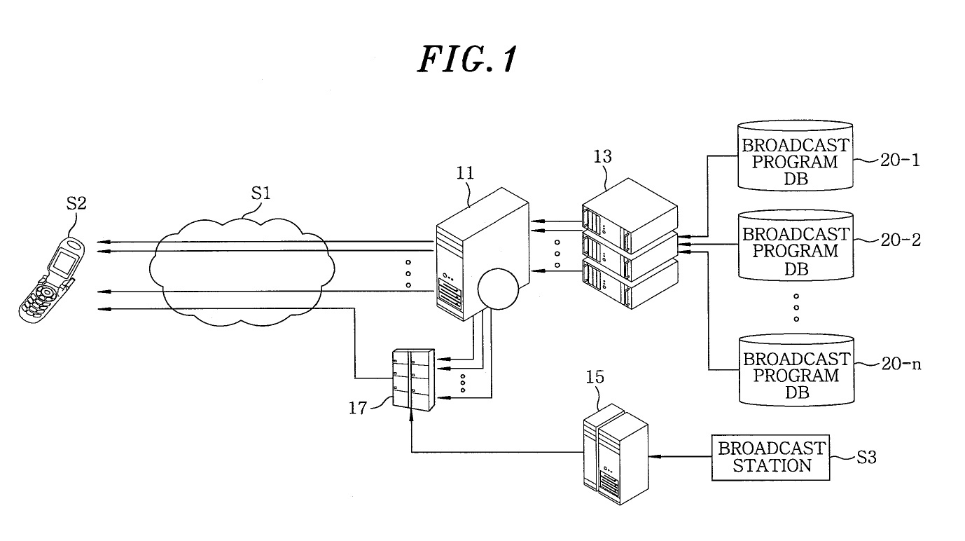

FIG. 1 shows a block diagram of an apparatus for providing preview channel guide information in a digital broadcast network in accordance with an embodiment of the present invention. The apparatus includes a broadcast control server 11, an encoding server 13, an EPG (Electronic Program

Guide) providing server 15, a preview generation server 17, and broadcast program databases (DBs) 20-1, 20-2, . . . , and 20-n.

The broadcast control server 11 identifies a signal received from a mobile communication terminal S2 via a wired/wireless network S1. If it is identified that the signal corresponds to a preview channel selection signal, the broadcast control server 11 provides the encoding server 13 with the preview channel selection signal to acquire digital broadcast programs encoded into multiple layers. Then, the broadcast control server 11 provides the preview generation server 17 with the digital broadcast programs received from the encoding server 13.

Further, when a user who uses the mobile communication terminal S2 make a request for a channel change to a specific channel using various user interfaces such as a remote controller, touch screen or the like, the broadcast control server 11 transmits a program of the specific channel among the digital broadcast programs received from the encoding server 13 to the mobile communication terminal S2 via the wired/wireless network S1.

The encoding server 13 reads out respective digital broadcast program channel sources stored in the broadcast program DBs 20-1, 20-2, . . . , and 20-n, and encodes them into multiple layers so that multiple program preview layers can be separately displayed on one screen. The respective digital broadcast programs encoded into multiple layers are provided to the broadcast control server 11.

The EPG providing server 15 obtains EPG information on the respective digital broadcast programs from a broadcast station S3 in response to a request from the preview generation server 17, and then provides the preview generation server 17 with the EPG information on the respective digital broadcast programs.

The preview generation server 17 requests the EPG providing server 15 to provide the EPG information on the respective digital broadcast programs when the digital broadcast programs are received from the broadcast control server 11. The preview generation server 17 extracts preview layers to be displayed from the respective digital broadcast programs so that the preview layers can be displayed with a predetermined preview video quality. Further, the preview generation server 17 combines the extracted preview layers with the EPG information provided from the EPG providing server 15 to generate a real time preview channel. The EPG information and the preview layers are loaded on the generated preview channel and are transmitted to the mobile communication terminal S2 via the wired/wireless network S1.

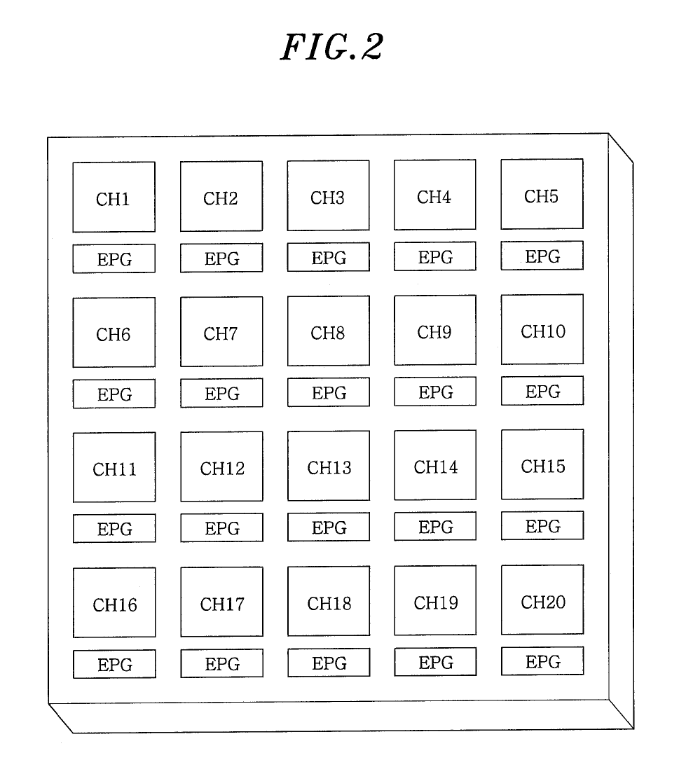

Here, as shown in FIG. 2, the preview channel is configured with combinations of the preview layers extracted from the respective broadcast program and the EPG information of the corresponding programs. Here, the combination of the preview layers and the EPG information is referred to as a sub-preview channel. The preview channel may be displayed including an advertisement inserted therein by a digital broadcast network provider.

The mobile communication terminal S2 displays a channel transmitted from the broadcast control server 11 or the preview generation server 17 on the screen. Further, when a user selects a specific sub-preview channel among a plurality of sub-preview channels, i.e., among the combinations of the preview layers and the EPG information, the mobile communication terminal S2 reproduces only audio of the selected sub-preview channel. Additionally, when the user requests a channel change to an actual channel of a sub-preview channel, the mobile communication terminal S2 enlarges the sub-preview channel to display over a full screen during a delay time of the channel change, and requests the broadcast control server 11 to provide the desired actual channel.

The broadcast program DBs 20-1, 20-2, . . . , and 20-n store the respective digital broadcast program channel sources.

Next, a description will be given on a procedure of providing preview channel guide information in a digital broadcast network in accordance with the embodiment of the present invention having the configuration as above.

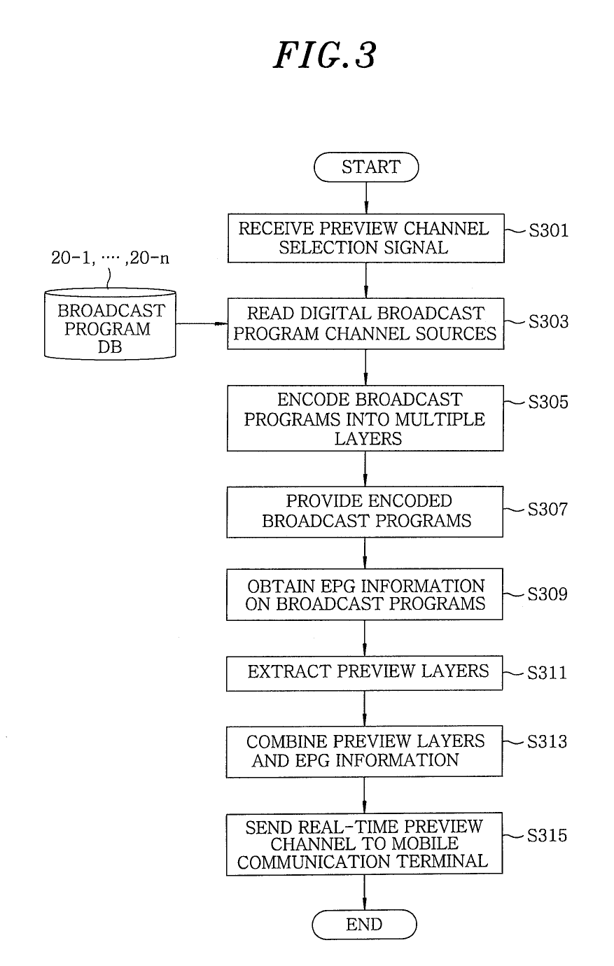

FIG. 3 illustrates a flowchart sequentially showing a method for providing preview channel guide information in a digital broadcast network.

First, it is assumed that the respective digital broadcast program channel sources are stored in the broadcast program DBs 20-1, 20-2, . . . , and 20-n.

Under the assumption, in step S301, when a preview channel selection signal is received from the mobile communication terminal S2, the broadcast control server 11 provides the received preview channel selection signal to the encoding server 13.

Then, the encoding server 13 reads out the respective digital broadcast program channel sources from the broadcast program DBs 20-1, 20-2, . . . , and 20-n in response to the preview channel selection signal in step S303, and encodes them into multiple layers so that multiple program preview layers can be separately displayed on one screen in step S305. The respective digital broadcast programs encoded into multiple layers are then provided to the broadcast control server 11.

Next, the broadcast control server 11 provides the preview generation server 17 with the respective digital broadcast programs encoded into multiple layers in step S307.

Then, the preview generation server 17 requests the EPG providing server 15 to provide EPG information.

Next, the EPG providing server 15 obtains EPG information on the respective broadcast programs from the broadcast station S3 in response to the EPG information request from the preview generation server 17 in step S309. The EPG information on the respective broadcast programs is provided to the preview generation server 17.

Subsequently, in step S311, the preview generation server 17 extracts preview layers to be displayed from the respective digital broadcast programs encoded into multiple layers so that the preview layers can be displayed with a predetermined preview video quality for each broadcast program.

Thereafter, in step S313, the preview generation server combines the EPG information on the respective broadcast programs from the EPG providing server 15 and the extracted preview layers to generate a real time preview channel. Thus, the preview layers of the respective broadcast programs and EPG information on the corresponding programs can be displayed in association with each other on a screen of the mobile communication terminal S2.

Lastly, in step S315, the combined EPG information and preview layers are loaded on the generated real time preview channel and the real time preview channel is transmitted to the mobile communication terminal S2 via the wired/wireless network S1. The wired/wireless network S1 may be implemented as any of a wireless network and a wired network (Internet network) including a mobile communication network which can provide digital broadcast services.

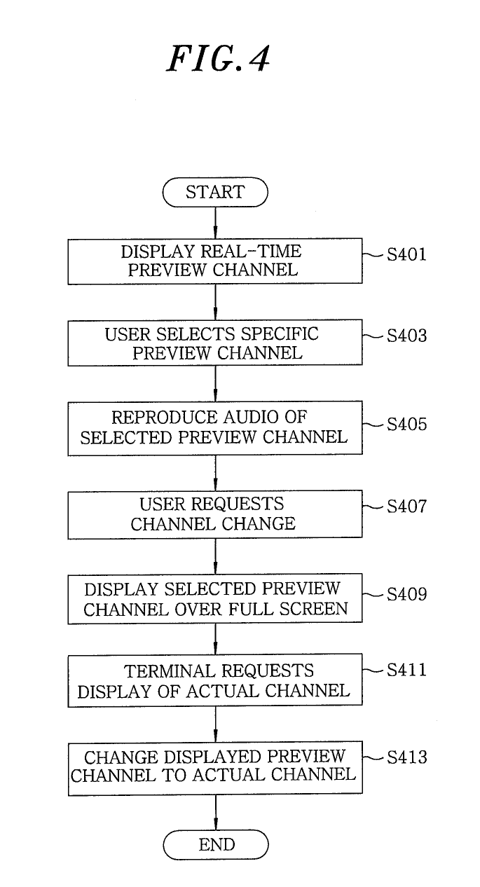

FIG. 4 illustrates a flowchart showing a control method of channel selection or channel change while providing preview channel guide information in a digital broadcast network in accordance with the embodiment of the present invention.

First, in step S401, the preview generation server 17 sends a real-time preview channel carrying a combination of preview layers and EPG information to the mobile communication terminal S2. Then, the real-time preview channel is displayed on a screen of the mobile communication terminal S2.

If a user who uses the mobile communication terminal S2 selects a specific sub-preview channel among the displayed combinations of preview layers and EPG information using various user interfaces such as a remote controller, a touch screen or the like in step S403, the mobile communication terminal S2 reproduces only audio of the selected sub-preview channel in step S405.

Thereafter, if the user makes a request for a channel change to an actual channel of the selected sub-preview channel in step S407, the mobile communication terminal S2 enlarges the selected sub-preview channel over a full screen in step S409. Subsequently, the mobile communication terminal S2 requests the broadcast control server 11 to provide an actual channel of the selected sub-preview channel in step S411. Then, the broadcast control server 11 searches and transmits a program of the actual channel of the sub-preview channel among the digital broadcast programs encoded into multiple layers to the mobile communication terminal S2. Thus, the display of the sub-preview channel is changed to the program of the desired actual channel in step S413.

As described above, the present invention encodes respective broadcast programs into multiple layers, extracts preview layers from the respective broadcast programs encoded into multiple layers, and combines the extracted preview layers with EPG information to thereby establish a real-time preview channel. Further, the present invention provides the established real-time preview channel to a mobile communication terminal via a digital television broadcast network when a user requests the real-time preview channel or a channel change. Therefore, the broadcast network provider does not need to have additional expensive encoder equipment for generating the real-time preview channel, and a user-sensory channel delay time can be significantly reduced by displaying a preview of selected channel by the user.

In addition, the present invention allows the broadcast network provider to create a profit by inserting an advertisement into the real-time preview channel. Also, the user can utilize the preview channel and program information in real time using the mobile communication terminal, thereby searching and selecting a preferable channel in a more convenient way.

Meanwhile, the method for providing preview channel guide information in a digital broadcast network in accordance with present invention may be implemented as computer-executable codes on a computer-readable recording medium. Any kind of data recording devices that can be read by a computer system may be employed as the computer-readable recoding medium. Examples of the computer-readable recording medium include ROM, RAM, CD-ROM, magnetic tape, floppy disk, optical data storage device and the like, and such recording medium may be implemented in form of a carrier wave (e.g., transmission via Internet, etc.). Also, the computer-executable codes or program can be distributed and executed by the computer system which is connected to a network so as to distributively perform the functions of the present invention.

While the invention has been shown and described with respect to the embodiments, it will be understood by those skilled in the art that various changes and modification may be made without departing from the scope of the invention as defined in the following claims.

What is claimed is:

1. An apparatus for providing preview channel guide information in a digital broadcast network, comprising:
an encoding server for encoding respective broadcast program channel sources stored in multiple broadcast program databases;
a broadcast control server for providing the respective encoded broadcast programs received from the encoding server by request from a mobile communication terminal;
an electronic program guide (EPG) providing server for obtaining EPG information from a broadcast station; and
a preview generation server for extracting preview layers from the respective encoded broadcast programs and combining the extracted preview layers with the EPG information provided from the EPG providing server to generate a preview channel, wherein the preview channel includes the combinations of the preview layers and the EPG information as sub-preview channels.

2. The apparatus of claim 1, wherein, when a user who uses the mobile communication terminal selects the preview channel, the broadcast control server provides the respective encoded broadcast programs received from the encoding server to the preview generation server so that the preview generation server generates and provides the preview channel to the mobile communication terminal.

3. The apparatus of claim 1, wherein, when a user makes a request for a channel change to a specific channel, the broadcast control server transmits a program of the specific channel among the respective encoded broadcast programs to the mobile communication terminal.

4. The apparatus of claim 3, wherein the mobile communication terminal displays a preview of the specific channel over a full screen until the specific channel is completely transmitted.

5. The apparatus of claim 4, wherein, if the specific channel is completely transmitted, the mobile communication terminal changes the display of the preview into that of the specific channel.

6. The apparatus of claim 1, wherein the encoding server reads the respective broadcast program channel sources stored in the broadcast program databases and encodes the respective broadcast programs into multiple layers such that the preview layers are separately displayed on one screen.

7. The apparatus of claim 1, wherein the preview generation server extracts preview layers to be displayed from the respective encoded broadcast programs so as to provide a predetermined preview video quality for each broadcast program.

8. The apparatus of claim 1, wherein the preview channel includes an advertisement inserted thereinto and is transmitted to a mobile communication terminal via a wired/wireless network.

9. The apparatus of claim 8, wherein the wired/wireless network is any wired/wireless network which can provide digital broadcast services.

10. A method for providing preview channel guide information in a digital broadcast network, comprising:
encoding respective broadcast program channel sources stored in multiple broadcast program databases in response to a preview channel selection signal from a mobile communication terminal;
extracting preview layers from the encoded respective broadcast programs; and
combining the preview layers and EPG information received from a broadcast station to generate and transmit a preview channel to the mobile communication terminal, wherein the preview channel includes the combinations of the preview layers and the EPG information as sub-preview channels.

11. The method of claim 10, further comprising:
transmitting, at the mobile communication terminal, a channel change signal to a specific channel when a user who uses the mobile communication terminal make a request for the channel change to the specific channel; and
displaying, at the mobile communication terminal, a preview of the specific channel over a full screen until the specific channel is completely transmitted.

12. The method of claim 11, wherein if the specific channel is completely transmitted, the mobile communication terminal changes the display of the preview into that of the specific channel.

13. The method of claim 10, wherein said encoding the respective broadcast program channel sources includes reading the respective broadcast program channel sources stored in the broadcast program databases and encoding the respective broadcast programs into multiple layers such that preview layers are separately displayed on one screen.

14. The method of claim 10, wherein the preview layers are extracted from the respective encoded broadcast programs so as to provide a predetermined preview video quality for each broadcast program.

15. The method of claim 10, wherein the preview channel includes an advertisement inserted thereinto and is transmitted to the mobile communication terminal via a wired/wireless network.

16. The method of claim 15, wherein the wired/wireless network is any wired/wireless network which can provide digital broadcast services.

17. The method of claim 10, further comprising:
when a user who uses the mobile communication terminal selects a specific sub-preview channel while the preview channel is being displayed, reproducing only audio of the specific sub-preview channel.
